(19) United States
(12) Patent Application Publication
(10) Pub. No.: US 2025/0085959 A1
(43) Pub. Date: Mar. 13, 2025

(54) REMOTE CONTROLLER KEY UPDATING METHOD AND DEVICE, REMOTE CONTROLLER, AND STORAGE MEDIUM

(71) Applicant: SHENZHEN TCL NEW TECHNOLOGY CO., LTD., Shenzhen, Guangdong (CN)

(72) Inventor: Ke QI, Shenzhen, Guangdong (CN)

(73) Assignee: SHENZHEN TCL NEW TECHNOLOGY CO., LTD., Shenzhen, Guangdong (CN)

(21) Appl. No.: 18/727,709

(22) PCT Filed: Nov. 3, 2022
(86) PCT No.: PCT/CN2022/129398

§ 371 Date: Jul. 10, 2024

(30) Foreign Application Priority Data
Jan. 20, 2022 (CN) 202210067739.9

(51) Int. Cl. G06F 8/65; G06F 3/041; H04N 21/422

(52) U.S. Cl. CPC G06F 8/65; G06F 3/0412; H04N 21/42208

(57) ABSTRACT

The present disclosure provides a remote controller key updating method and device, a remote controller, and a storage medium. In the remote controller key updating method provided by the present disclosure, a key on the remote controller is set to be a touch display device, and when display information on the key needs to be changed, for the key that needs to be changed, the display information on the touch device on the key that needs to be changed is updated according to updated key update information. Therefore, remote controllers having different functions do not need to be manufactured, and the universality and flexibility of the remote controller are improved.

This application claims priority to Chinese Application No. 202210067739.9, entitled “REMOTE CONTROLLER KEY UPDATING METHOD AND DEVICE, REMOTE CONTROLLER, AND STORAGE MEDIUM”, filed on Jan. 20, 2022. The entire disclosures of the above applications are incorporated herein by reference.

### FIELD OF THE INVENTION

The present disclosure relates to the field of the electronic products, and specifically to a remote-control key updating method, device, remote control and storage medium.

### BACKGROUND

With the popularization of various kinds of electronic products, the requirements for the diversification of functions of a single electronic product are getting higher and higher, for example, a mobile phone not only meets the needs for calls, but also plays the role of a camera in the present society. Similarly, for some electronic products that need to be controlled by a remote control, these electronic products that need to be controlled by the remote control are also accompanied by the need to have different functions. For example, the traditional function of a television (TV) is to receive television signals and play different images. However, nowadays TV not only need to have this function, but also need to have networking, downloading different APP, and playing TV signals from the network through different APP, and consequently the remote control of the TV has more and more keys, and due to the different positioning of the different TVs, for different customers, or sold in different regions, the functions supported by different TVs will also be different. This leads to different TVs need to be equipped with different remote controls, which leads to more and more models of remote controls, management difficulties and spends a lot of financial resources and manpower in design, production, and maintenance.

In addition, once the remote control is in the hands of the user, the keys cannot be changed, which also makes the flexibility of keys of the remote control very poor, and when the user needs to customize APPs, there is no corresponding key to quickly open these APPS, which makes the user's experience of using the remote control also very poor. Therefore, how to improve the function of the keys of the remote control to achieve customized changes becomes a problem to be solved.

### SUMMARY

### Technical Problem

How to improve the remote-control key function to implement customized change.

### Solution to Technical Problem

### Technical Solution

An embodiment of the present disclosure provides a method for updating keys of a remote control. The keys on the remote control are touch display devices. The method comprises:

detecting whether key update information is received;

when the key update information is received, updating the display information of the touch display devices on the keys of the remote control according to the key update information.

In some embodiments of the present disclosure, updating the display information of the touch display devices on the keys of the remote control according to the key update information comprises:

parsing the key update information to obtain a target key that needs to update the key information thereof;

updating display information on the touch display device of the target key according to the key update information.

In some embodiments of the present disclosure, after the detection of whether the key update information is received, the method further comprises:

when the key update information is not received, obtaining an operating mode of a controlled device corresponding to the remote control;

updating the touch display devices on the remote control to display the key information of the corresponding mode according to the operation mode of the controlled device.

In some embodiments of the present disclosure, updating the touch display devices on the remote control to display the key information of the corresponding mode according to the operation mode of the controlled device comprises:

when the operating mode of the controlled device is a game mode, updating a part of the touch display devices on the remote control to display game key information according to the game mode.

In some embodiments of the present disclosure, updating the part of the touch display devices on the remote control to display the game key information according to the game mode comprises:

filtering out target keys required for the remote control to control a running game based on the running game in the game mode;

updating initial display information on the touch display device on the target keys required for the running game with game key information;

controlling the touch display devices on keys other than the target keys required for the running game to stop working.

In some embodiments of the present disclosure, updating the touch display devices on the remote control to display the key information of the corresponding mode according to the operation mode of the controlled device comprises:

when the operating mode of the controlled device is a text input mode, updating the touch display devices on the remote control to display input method key information in accordance with the text input mode according to the text input mode.

In some embodiments of the present disclosure, updating the touch display devices on the remote control to display the input method key information in accordance with the text input mode according to the text input mode comprises:

detecting whether the controlled device is set with a customized input method;

when no customized input method is set, based on a preset default input method, filtering out target keys needed by the remote control according to the default input method;

updating initial display information on the touch display devices on the target keys required by the default input method to key information required for the default input method;

when a customized input method has been set, based on the customized input method, filtering out target keys needed by the remote control according to the customized input method;

updating initial display information on the touch display devices on the target keys required by the customized input method to key information required for the customized input method.

In a second aspect, the present disclosure also provides a remote-control key updating device. The device includes a detection module and an updating module.

The detection module is configured for detecting whether key update information is received.

The updating module is configured for updating display information of touch display devices on keys of the remote control according to the key update information when receiving the key update information.

In some embodiments of the present disclosure, the updating module is configured for:

parsing the key update information to obtain a target key that needs to update the key information thereof;

updating display information on the touch display device of the target key according to the key update information.

In some embodiments of the present disclosure, the updating module is configured for:

when the key update information is not received, obtaining an operating mode of a controlled device corresponding to the remote control;

updating the touch display devices on the remote control to display the key information of the corresponding mode according to the operation mode of the controlled device.

In some embodiments of the present disclosure, the updating module is configured for:

when the operating mode of the controlled device is a game mode, updating a part of the touch display devices on the remote control to display game key information according to the game mode.

In some embodiments of the present disclosure, the updating module is configured for:

filtering out target keys required for the remote control to control a running game based on the running game in the game mode;

updating initial display information on the touch display device on the target keys required for the running game with game key information;

controlling the touch display devices on keys other than the target keys required for the running game to stop working.

In some embodiments of the present disclosure, the updating module is configured for:

when the operating mode of the controlled device is a text input mode, updating the touch display devices on the remote control to display input method key information in accordance with the text input mode according to the text input mode.

In some embodiments of the present disclosure, the updating module is configured for:

detecting whether the controlled device is set with a customized input method;

when no customized input method is set, based on a preset default input method, filtering out target keys needed by the remote control according to the default input method;

updating initial display information on the touch display devices on the target keys required by the default input method to key information required for the default input method;

when a customized input method has been set, based on the customized input method, filtering out target keys needed by the remote control according to the customized input method;

updating initial display information on the touch display devices on the target keys required by the customized input method to key information required for the customized input method.

In a third aspect, the present disclosure also provides a remote control that includes a plurality of touch display keys, a processor, and a memory storing computer program executable by the processor to implement steps in the methods for updating keys of a remote control.

In a fourth aspect, the present disclosure also provides a computer readable medium storing computer program executable by a processor to implement steps in the methods for updating keys of a remote control.

### Beneficial Effect of the Present Disclosure

### Advantageous Effect

The remote-control key updating method provided in the present disclosure sets the keys on the remote control as touch display devices, and when the display information on the key needs to be changed, the key that needs to be changed can be updated in accordance with the updated key updating information to update the display information on the touch devices on the keys that need to be changed, so that there is no need to manufacture remote controls that meet different functions, thus improving the versatility and flexibility of the remote control.

### BRIEF DESCRIPTION OF THE DRAWINGS

### Description of the Drawings

In order to more clearly illustrate the technical solutions in the embodiments of the present disclosure, the drawings required to be used in the description of the embodiments will be briefly introduced below, and it is obvious that the drawings described below are only some embodiments of the present disclosure, and for those skilled in the art, other drawings can be obtained according to these drawings without creative labor.

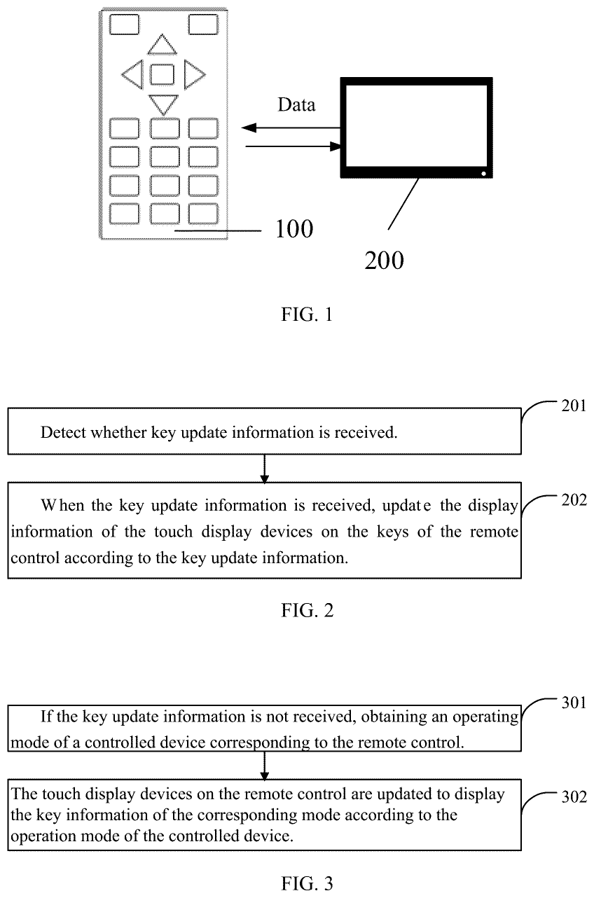

FIG. 1 is a schematic diagram of a scenario of a remote-control key updating system of an embodiment of the present disclosure.

FIG. 2 is a flowchart of a remote-control key updating method according to an embodiment of the present disclosure.

FIG. 3 is a flowchart of an embodiment of a remote-control key updating method according to another embodiment of the present disclosure.

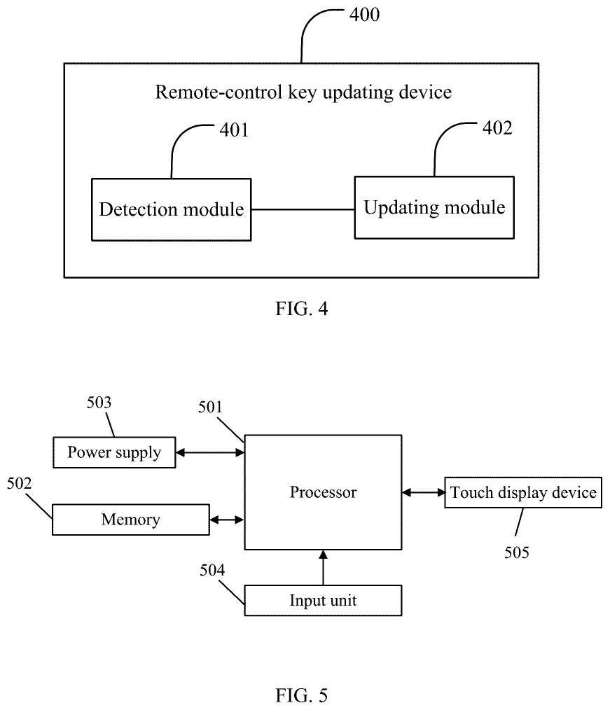

FIG. 4 is a block diagram illustrating functional modules of a remote-control key updating device according to an embodiment of the present disclosure.

FIG. 5 is a schematic diagram of the remote control according to the embodiment of the present disclosure.

### EMBODIMENT OF THE PRESENT DISCLOSURE

### Detailed Description of the Present Disclosure

The technical solutions in the embodiments of the present disclosure will be clearly and completely described below in conjunction with the accompanying drawings in the embodiments of the present disclosure, and it is obvious that the described embodiments are only part of the embodiments of the present disclosure, not all embodiments. Based on the embodiments in the present disclosure, all other embodiments obtained by a person skilled in the art without creative work fall within the scope of protection of the present disclosure.

In the description of the present disclosure, it is understood that the terms “first” and “second” are used for descriptive purposes only and should not be construed as indicating or implying relative importance or implying the number of technical features indicated. Thus, defining the “first” and “second” features may explicitly or implicitly include one or more of these features. In the description of this application, “plurality” means two or more than two, unless otherwise expressly and specifically qualified.

In the present disclosure, the word “exemplary” is used to mean “to be used as an example, illustration or illustration”. Any embodiment described as “exemplary” in this application is not necessarily to be construed as being superior or advantageous over other embodiments. In order to enable any person skilled in the art to realize and use the present disclosure, the following description is given. In the following description, details are listed for the purpose of interpretation.

It should be understood that a person of ordinary skill in the art can recognize that the present disclosure can be realized without the use of these specific details. In other cases, the structure and process of the known application will not be elaborated in order to avoid unnecessary details obscure the description of the application. Therefore, the present disclosure is not intended to be limited to the embodiments shown, but is consistent with the widest possible range of principles and features disclosed in the present disclosure.

The application provides a remote-control key updating method, device, remote control and storage medium, which are described in detail below.

Referring to FIG. 1, FIG. 1 is a schematic diagram of a scenario of a remote-control key updating method of an embodiment of the present disclosure, wherein the remote-control key updating system may comprise a remote control 100 and a controlled device 200, and the controlled device 200 can transmit data to the remote control 100. The remote control 100, as shown in FIG. 1, may obtain remote control key configuration data stored in the controlled device 200 to perform the remote-control key updating method of the present disclosure.

In the embodiments of the present disclosure, the remote control 100 is not limited to a remote control that may be a remote control accompanying a variety of devices such as a television (TV), an air conditioner, a remote-control car, a remote-control airplane, and so on, but may also be a terminal such as a mobile phone, a tablet, a smart wearable device, and other terminal that is equipped with a remote-control application. When a terminal such as a mobile phone, a tablet or other terminal is equipped with a remote-control application, the mobile phone or tablet and other terminal can open the remote-control application to display a remote control interface, wherein the remote control interface may include a plurality of virtual keys, and the terminal can receive the user's input operation through the plurality of virtual keys in the remote control interface to control a controlled device, and the controlled equipment may specifically refer to any type of electronic devices such as a television, an air conditioner, a remote control car, a remote control airplane, etc.

The schematic diagram of a scenario of a remote-control key updating system shown in FIG. 1 is only an example, and the remote-control key updating system and the scenario described in the embodiments of the present disclosure are for the purpose of more clearly illustrating the technical solutions of the embodiments of the present disclosure and do not constitute a limitation on the technical solutions provided in the embodiments of the present disclosure, and those skilled in the art can know that, with the evolution of the remote-control key updating system and the emergence of new business scenarios, the technical solutions provided by the embodiments of the present disclosure are equally applicable to similar technical problems.

As shown in FIG. 2, FIG. 2 schematically illustrates a flow chart of a remote-control key updating method according to an embodiment of the present disclosure. The remote-control key updating method can include steps 201 to 202 as follows:

201. It is detected whether key update information is received.

Typically, the purpose of the remote control is to control the device, and the key functions of the remote-control keys are matched to the functions of the device being controlled. When the functionality of the controlled device is changed, the functionality of the remote control needs to be changed in order to meet the control needs of the remote control and the controlled device. For the remote control, it is relatively easy to change the key functions of the remote-control keys, but it is more difficult to change the key information on the keys. For example, the original function of a key A on the remote control is to confirm the current command, so usually the key information (key text) on this key A is also “OK”. Assuming that it is necessary to change the function of the key A, for example, to change the OK function to a cancel function, it is sufficient to adjust the key control program of the remote control, but the information of the word “OK” on the key of the remote control cannot be changed, which is a difficult problem. Therefore, the present disclosure can change the rubber keys of the remote control to a touch display device, so that when the information of the word “OK” on the key needs to be changed, the word “OK” on the touch display device can be updated to the word “Cancel”. In this way, it can meet the problem that after the key function of the remote control is changed, the key information on the key can also be matched.

When making a change in the key information of the remote control, it is necessary to send relevant configuration information, such as the key information of the remote control to be changed, to the remote control so that the remote control can modify the text on the key information. The way to send the key update information of the remote control to the remote control can be done through the controlled device, or the remote control can be connected to a network so that the key update information of the remote control can be sent to the remote control through the network. For example, if the controlled device is a television (TV), connecting the TV to the network or the cloud, downloading the remote-control key information to be updated to the TV through the TV, and then sending it to the remote control through the TV. If the network or the cloud is used, the remote control can also be equipped with a device corresponding to the network, and the key information to be updated can be sent directly through the network or the cloud to the remote control that needs to be updated with the key information. Among them, there are various ways to send the key update information to the remote control, the details of which are not limited herein.

Among them, the detection of whether the remote control receives the key update information can be done when the remote control starts the controlled device and the remote control automatically detects whether it receives the relevant update information, or it can be done in real time, as is not limited herein.

202. If the key update information is received, updating the display information of the touch display devices on the keys of the remote control according to the key update information.

According to step 201 above, it can be obtained that when the remote control receives the key update information, then it is necessary to update the key information on the remote control. Specifically, when the key update information is received, the key information may be updated for each key on the remote control one by one according to the key update information, for example: the key update information includes: updating the key information of key 1 to “X”, updating the key information of key 2 to “Y”, and leaving the key information of key 3 unchanged, and so on, so that the corresponding keys can be operated according to the key update information. In this regard, it should be noted that updating the key information on the key refers to updating the key information on the touch display device on the corresponding key, and words such as “updating the key information on the key”, etc. appearing in the following text, all refer to updating the key information on the corresponding touch display device on the key.

In this case, it is necessary to update the key function at the same time as or before updating the key information, and it is not possible to update only the key information on the key as the key function remains unchanged even after the key information is updated. Of course, the present disclosure relates to making changes to the key information on the key, and does not include making changes to the key function, and therefore does not describe the process and scheme for making changes to the key function.

In order to better realize the embodiment of the present disclosure, in one embodiment of the present disclosure, updating the display information of touch display devices on the remote-control keys based on the key update information comprises:

Parsing the key update information to obtain a target key that needs to update the key information thereof; and updating display information on the touch display device of the target key according to the key update information.

In some cases, when updating the key information on the remote control, not all of the key information is updated. As a result, there is no need to analyze each key individually based on the key update information, which makes the update less efficient. Therefore, when the key update information is obtained, the key update information can be parsed to obtain the key information to be updated. Still in accordance with the case in the above embodiment, for example: the key information of key 1 is updated to “X”, the key information of key 2 is updated to “Y”, and the key information of key 3 remains unchanged, and this key information is parsed at this moment, the analysis result obtained is that key 1 and key 2 need to be updated, key 3 does not need to be updated at this moment, so that there is no need to analyze key 3 again in the updating stage, and key 1 and key 2 need to be operated in the update stag, which can improve the efficiency of updating.

In one embodiment of the present disclosure, after the detection of whether the key update information is received, as shown in FIG. 3, the method may further comprise steps 301 to 302 as follows:

301. If the key update information is not received, obtaining an operating mode of a controlled device corresponding to the remote control.

According to the above embodiments, it can be seen that not every time the remote control is used, or at all times, the key information of the remote control needs to be updated. Therefore, it also includes the case when the key update information is not received. As for the devices that are now controlled by the remote control, they usually have multiple functions to meet the different usage needs of users in various scenarios.

For example, the device controlled by the remote control may be a television set, which is known to have multiple functions nowadays, including connecting to digital signals to watch a television program from a television station; or connecting to a network to watch a television program provided by the network; or, connecting to an external gaming device to act as a pure display device. For different application scenarios, there are different needs for the remote control. For example, if the TV needs to be connected to the network to watch network programs, it usually needs to go through a specific APP to watch, such as downloading a video APP on the TV, similar to iQiyi, so that viewers can watch videos on iQiyi; or when users need to play games through external gaming devices, including external Sony's PS4 (PlayStation 4) and other scenarios.

For different scenarios, the user's need for keys on the remote control are also different. Assuming that the user is playing a game, the keys on the remote control are not needed because it is not possible to apply the remote control to the game operation. If the remote control is adapted to the game, the remote control will not be temporarily discarded, allowing the remote control to act as a gamepad. This will help the user to eliminate the need for the gamepad hardware. Therefore, if the remote control can make changes to the key information according to the user's current operation mode of the TV, it can greatly improve the versatility of the remote control, and at the same time, it can improve the user's experience to a certain extent. Therefore, if there is a need to switch different display information on the remote control keys according to different modes, it is necessary to obtain which specific mode the TV is currently in.

If the controlled device is still a TV for example, when the TV switches modes, it still needs the remote control to switch modes, such as the mode switch key on the remote control, and if the mode switch key on the remote control is clicked once, the mode switch key can be clicked as a start signal for detecting the current mode of operation of the TV, so as to detect the current operation mode of the TV. It can be understood that, according to different devices controlled by the remote control, the way to switch modes may be different, therefore, according to the specific situation, different settings can be set to obtain the current operation mode of the currently controlled device, which is not limited herein.

302. The touch display devices on the remote control are updated to display the key information of the corresponding mode according to the operation mode of the controlled device.

According to the above step 301, it can be obtained that since the controlled device has different control needs for the remote control in different modes, the key information on the remote control can be changed according to the different operation modes, so as to facilitate the control operation of the user. Among them, the method of updating is the same as the above embodiment, and the details will not be repeated here. Of course, these different key information under the corresponding modes may be pre-set and stored in the remote control, or they may be set specifically according to the actual situation.

In one embodiment of the present disclosure, updating the touch display devices on the remote control to display the key information of the corresponding mode according to the operation mode of the controlled device comprises:

If the operating mode of the controlled device is a game mode, updating a part of the touch display devices on the remote control to display game key information according to the game mode.

If the controlled device is still a TV for example, since gaming is now increasingly being used by users as a regular entertainment method, for TVs, the game mode accounts for an increasingly high percentage of time in the running process of TV. At this time, the TV is in the game mode, the remote control can display the key information as the key information adapted to the game, thereby facilitating the user to carry out the game-related control operations, and avoiding the problem that the remote control is abandoned or the remote control cannot be able to play the game well when the user is playing the game.

In one embodiment of the present disclosure, updating the part of the touch display devices on the remote control to display the game key information according to the game mode comprises:

Filtering out target keys required for the remote control to control a running game based on the running game in the game mode; updating initial display information on the touch display device on the target keys required for the running game with game key information; and controlling the touch display devices on keys other than the target keys required for the running game to stop working.

Since there are various types of games supplied in the market today, it is still possible that the user's need for operational control of the game may not be satisfied if only one or several types of pre-determined game mode key information are used for matching. Therefore, in order to better adapt to the user's control operation, the key information control mode of the running game can be obtained when the user is running the game mode. For example, if the user is currently using the game mode of the TV to run a game named “Cyberpunk 2077” through PS4, the current user's key information setting for this game can be obtained, for example, the setting of the gamepad key information in the user's PS4 can be obtained, and then the setting of the remote-control key information can be converted into the user's setting of the gamepad key information according to the user's setting of the gamepad key information, so that the key information on the remote control can be updated.

Since not all keys on the remote control are applied to the game when the game is played in the game mode, after the keys of the remote control are set according to the currently running game, the work of the touch display devices on the other non-game keys can be stopped, which prevents the user from accidentally touching the other unnecessary keys during the operation of the game, thereby affecting the operation of the game.

In order to better realize the embodiment of the present disclosure, in one embodiment of the present disclosure, said updating the touch display devices on the remote control to display the key information of the corresponding mode according to the operation mode of the controlled device comprises:

If the operating mode of the controlled device is a text input mode, updating the touch display devices on the remote control to display input method key information in accordance with the text input mode according to the text input mode.

According to the above embodiment, it may also be used by the user for other modes in the non-game mode, such as enumerated in the above embodiments, the user may also watch a television program in the network through the network, such as watching an online television program through the iQiyi APP. However, a problem arises in that if users need to watch online TV programs, for example, when they need to watch a certain TV series, the TV series does not necessarily appear on the home page of the iQiyi APP, but the user needs to manually search for it so as to obtain a viewing link for a particular TV series. Therefore, this causes a problem in that the user is unable to perform text input via the remote control so as to retrieve the relevant TV series.

Therefore, in order to adapt to such similar use scenario, if the remote control device retrieves a scene where the user needs to type text, the remote control can automatically switch to a key mode in which typing can be performed, thereby assisting the user in performing the text input. For example, the key information of the remote control can be displayed as a nine-square grid input method, or when the remote control has enough keys, the key information of the remote control can be converted into a full keyboard input method, which may of course be set by the specific situation, and it is not limited herein.

In one embodiment of the present disclosure, said updating the touch display devices on the remote control to display the input method key information in accordance with the text input mode according to the text input mode comprises:

Detecting whether the controlled device is set with a customized input method; if no customized input method is set, based on a preset default input method, filtering out target keys needed by the remote control according to the default input method; updating initial display information on the touch display devices on the target keys required by the default input method to key information required for the default input method; if a customized input method has been set, based on the customized input method, filtering out target keys needed by the remote control according to the customized input method; updating initial display information on the touch display devices on the target keys required by the customized input method to key information required for the customized input method.

As it can be obtained according to the above embodiments, the user may need a scenario of text input, and typing habits may vary for different users. Therefore, there is also a need to provide a customized matching method to meet the typing habits of different users.

If the user has set a customized input method, the key information on the corresponding keys can be updated according to the input method set by the user. If the user does not set a customized key, the key information can be updated according to the default input method stored in the remote control.

The way for the user to set the customized input method can be to download the input method through the controlled device of the remote control, to connect the remote control to a network and directly download the corresponding input method that the user is accustomed to through the network, etc., and the details are not limited herein.

The remote-control key updating method provided in the present disclosure sets the keys on the remote control as touch display devices, and when the display information on the key needs to be changed, the key that needs to be changed can be updated in accordance with the updated key updating information to update the display information on the touch devices on the keys that need to be changed, so that there is no need to manufacture remote controls that meet different functions, thus improving the versatility and flexibility of the remote control.

In order to better implement the remote-control key updating method in the embodiments of the present disclosure, the embodiment of the present disclosure also provides a remote-control key updating device. As shown in FIG. 4, the remote-control key updating device 400 comprises a detection module 401 and an updating module 402.

The detection module 401 is configured to detect whether key update information is received.

If the key update information is received, the updating module 402 updates display information of the touch display devices on the keys of the remote control according to the key update information, and updates the display information of the touch display device on the key of the remote control.

The remote-control key updating device provided in the present disclosure sets the keys on the remote control as touch display devices, and then obtains whether there is new key update information through the detection module 401, and if new key update information is obtained, then updates the display information on the touch display devices on the keys that need to be changed through the updating module 402 according to the updated key update information, so that there is no need to manufacture remote controls that meet different functions, thus improving the versatility and flexibility of the remote control.

In some embodiments of the present disclosure, the updating module 402 is further specifically used to:

Parse the key update information to obtain a target key that needs to update the key information thereof; and

Update display information on the touch display device of the target key according to the key update information.

In some embodiments of the present disclosure, the updating module 402 is further specifically used to:

If the key update information is not received, obtain an operating mode of a controlled device corresponding to the remote control; and

Update the touch display devices on the remote control to display the key information of the corresponding mode according to the operation mode of the controlled device.

In some embodiments of the present disclosure, the updating module 402 is further specifically used to:

If the operating mode of the controlled device is a game mode, update a part of the touch display devices on the remote control to display game key information according to the game mode.

In some embodiments of the present disclosure, the updating module 402 is further specifically used to:

Filter out target keys required for the remote control to control a running game based on the running game in the game mode;

Update initial display information on the touch display device on the target keys required for the running game with game key information; and

Control the touch display devices on keys other than the target keys required for the running game to stop working.

In some embodiments of the present disclosure, the updating module 402 is further specifically used to:

If the operating mode of the controlled device is a text input mode, update the touch display devices on the remote control to display input method key information in accordance with the text input mode according to the text input mode.

In some embodiments of the present disclosure, the updating module 402 is further specifically used to:

Detect whether the controlled device is set with a customized input method;

If no customized input method is set, based on a preset default input method, filter out target keys needed by the remote control according to the default input method;

Update initial display information on the touch display devices on the target keys required by the default input method to key information required for the default input method;

If a customized input method has been set, based on the customized input method, filter out target keys needed by the remote control according to the customized input method; and

Update initial display information on the touch display devices on the target keys required by the customized input method to key information required for the customized input method.

Embodiments of the present disclosure further provide a remote control. The device includes a processor, a memory, and a computer program stored in the memory. The computer program can be executed by the processor to implement the steps in the remote-control key updating method of any of the embodiments of the present disclosure. The remote control integrates the remote-control key updating method provided by any of the embodiments of the present disclosure, as shown in FIG. 5 illustrating a schematic diagram of the remote control according to the embodiments of the present disclosure.

The remote control may include a processor 501 with one or more processing cores, a memory 502 with one or more computer-readable storage medium, a power supply 503, an input unit 504 and other components. It will be appreciated by those skilled in the art that the structure of the remote control illustrated in FIG. 5 does not constitute a limitation of the electronic device, and may include more or fewer components than illustrated, or a combination of certain components, or a different arrangement of components.

The processor 501 is the control center of the remote control, which utilizes various interfaces and lines to connect all parts of the entire remote control, and performs various functions and processes data of the remote control by running or executing software programs and/or modules stored in the memory 502, and calling the data stored in the memory 502, so as to carry out overall monitoring of the remote control. Optionally, the processor 501 may include one or more processing cores. The processor 501 can be a central processing unit (CPU), or other general-purpose processors, digital signal processors (DSPs), application-specific integrated circuits (ASICs), Field-Programmable Gate Arrays (FPGAs) or other programmable logic devices, discrete gate or transistor logic devices, discrete hardware components, etc. The general-purpose processor can be a microprocessor or the processor can also be any conventional processor, preferably, the processor 501 can integrate an application processor and a modem processor, where the application processor mainly deals with the operating system, the user boundary is the surface and the application, etc., and the modem processor mainly deals with wireless communication. It is understandable that the modem processor can also be left unintegrated into the processor 501.

The memory 502 can be used to store software programs and modules, and the processor 501 performs various functional applications and data processing by running software programs and modules stored in memory 502. The memory 502 may mainly include a storage program area and a storage data area, wherein the storage program area can store the operating system, at least one function required application (such as remote control button updater, etc.); The storage data area can store data created based on the use of the remote control, etc. In addition, memory 502 may include high-speed random access memory and may include non-volatile memory, such as at least one disk storage device, flash memory device, or other volatile solid-state memory device. Correspondingly, memory 502 may also include a memory controller to provide access from processor 501 to memory 502.

The remote control also comprises a power supply 503 that supplies power to each component, and preferably, the power supply 503 can be logically connected with the processor 501 through the power management system, so that the functions such as managing charging, discharging, and power consumption management can be realized through the power management system. The Power Supply 503 can also include any component such as one or more DC or AC power sources, recharging systems, power fault detection circuits, power converters or inverters, and power status indicators.

The remote control may also include an input unit 504, which can be used for receiving input numeric or character information and generating signal inputs related to user settings and function control.

The remote control may also include a plurality of touch display devices 505, and the plurality of touch display devices 505 are used for displaying key information on the remote control; And, when the user controls the keystrokes, the corresponding user's keystrokes.

Although not shown, the remote control can also include a display unit and the like, which will not be described herein. Specifically, in this embodiment, the processor 501 in the remote control will load the executable files corresponding to the process of one or more applications into the memory 502, and the processor 501 executes the application stored in the memory 502, so as to realize various functions. For example, the processor 501 executes the application to perform operations comprising:

detecting whether key update information is received;

when the key update information is received, updating the display information of the touch display devices on the keys of the remote control according to the key update information.

A person skilled in the art may understand that all or part of the steps in the various methods of the above embodiments may be completed by instructions or by instruction control related hardware, and the instructions may be stored in a computer-readable storage medium and loaded and executed by a processor.

For this purpose, the embodiment of the present disclosure provides a computer-readable storage medium, which may comprise: read-only memory (ROM, Read Only Memory), random access memory (RAM), disk or optical disc, etc. A computer program is stored thereon, and the computer program is loaded by a processor to perform the steps in any of the remote control button update methods provided in the embodiment of the present disclosure. For example, if a computer program is loaded by a processor, the following operations can be perform:

detecting whether key update information is received;

when the key update information is received, updating the display information of the touch display devices on the keys of the remote control according to the key update information.

In the above embodiments, the descriptions of each embodiment have their own emphasis, and the part that is not described in detail in a certain embodiment can be referred to the detailed description of the other embodiments above, and will not be repeated here.

In the specific embodiment, each of the above units or structures can be realized as an independent entity, or can be arbitrarily combined, and is realized as the same or several entities, and the specific embodiment of each of the above units or structures can be referred to in the previous method embodiment, and will not be repeated herein.

The specific implementation of each of the above operations can be found in the previous embodiment, which will not be repeated here.

The above detailed description of a remote-control key updating method and device provided by embodiments of the present disclosure is provided herein, and specific examples are applied herein to illustrate the principles and embodiments of the present disclosure, and the description of the above embodiments is only used to assist in the understanding of the method of the present disclosure and the core ideas thereof; at the same time, for those skilled in the art, based on the ideas of the present disclosure, there will be variations in specific implementations and the scope of application, and in summary, the contents of this specification should not be interpreted as a limitation of the present disclosure.

1. A method for updating keys of a remote control, wherein the keys on the remote control are touch display devices, and the method comprises:
detecting whether key update information is received;
when the key update information is received, updating the display information of the touch display devices on the keys of the remote control according to the key update information.

2. The method of claim 1, wherein updating the display information of the touch display devices on the keys of the remote control according to the key update information comprises:
parsing the key update information to obtain a target key that needs to update the key information thereof;
updating display information on the touch display device of the target key according to the key update information.

3. The method of claim 1, wherein, after the detection of whether the key update information is received, the method further comprises:
when the key update information is not received, obtaining an operating mode of a controlled device corresponding to the remote control;
updating the touch display devices on the remote control to display the key information of the corresponding mode according to the operation mode of the controlled device.

4. The method of claim 3, wherein updating the touch display devices on the remote control to display the key information of the corresponding mode according to the operation mode of the controlled device comprises:
when the operating mode of the controlled device is a game mode, updating a part of the touch display devices on the remote control to display game key information according to the game mode.

5. The method of claim 4, wherein updating the part of the touch display devices on the remote control to display the game key information according to the game mode comprises:
filtering out target keys required for the remote control to control a running game based on the running game in the game mode;
updating initial display information on the touch display device on the target keys required for the running game with game key information;
controlling the touch display devices on keys other than the target keys required for the running game to stop working.

6. The method of claim 3, wherein updating the touch display devices on the remote control to display the key information of the corresponding mode according to the operation mode of the controlled device comprises:
when the operating mode of the controlled device is a text input mode, updating the touch display devices on the remote control to display input method key information in accordance with the text input mode according to the text input mode.

7. The method of claim 6, wherein updating the touch display devices on the remote control to display the input method key information in accordance with the text input mode according to the text input mode comprises:
detecting whether the controlled device is set with a customized input method;
when no customized input method is set, based on a preset default input method, filtering out target keys needed by the remote control according to the default input method;
updating initial display information on the touch display devices on the target keys required by the default input method to key information required for the default input method;
when a customized input method has been set, based on the customized input method, filtering out target keys needed by the remote control according to the customized input method;
updating initial display information on the touch display devices on the target keys required by the customized input method to key information required for the customized input method.

8. The method of claim 3, wherein when the key update information is not received, obtaining the operating mode of the controlled device corresponding to the remote control comprises:
detecting whether a mode switch key on the remote control is clicked when the key update information is not received;
when the mode switch key on the remote control is clicked, obtaining the operation mode of the controlled device corresponding to the remote control.

9. The method of claim 1, wherein the detection of whether the key update information is received comprises:
detecting whether key update information sent by a controlled device of the remote control is received, the key update information sent by the controlled device being information obtained from a cloud of the remote control.

10-17. (canceled)

19. A remote control, comprising a plurality of touch display keys, a processor, and a memory storing computer program executable by the processor to implement operations comprising:
detecting whether key update information is received;
when the key update information is received, updating the display information of the touch display devices on the keys of the remote control according to the key update information.

20. A non-transitory computer readable medium storing computer program executable by a processor to implement
operations comprising:
detecting whether key update information is received;
when the key update information is received, updating the display information of the touch display devices on the keys of the remote control according to the key update information.

21. The remote control of claim 19, wherein updating the display information of the touch display devices on the keys of the remote control according to the key update information comprises:
parsing the key update information to obtain a target key that needs to update the key information thereof;
updating display information on the touch display device of the target key according to the key update information.

22. The remote control of claim 19, wherein, after the detection of whether the key update information is received, the operations further comprise:
when the key update information is not received, obtaining an operating mode of a controlled device corresponding to the remote control;
updating the touch display devices on the remote control to display the key information of the corresponding mode according to the operation mode of the controlled device.

23. The remote control of claim 22, wherein updating the touch display devices on the remote control to display the key information of the corresponding mode according to the operation mode of the controlled device comprises:
when the operating mode of the controlled device is a game mode, updating a part of the touch display devices on the remote control to display game key information according to the game mode.

24. The remote control of claim 23, wherein updating the part of the touch display devices on the remote control to display the game key information according to the game mode comprises:
filtering out target keys required for the remote control to control a running game based on the running game in the game mode;
updating initial display information on the touch display device on the target keys required for the running game with game key information;
controlling the touch display devices on keys other than the target keys required for the running game to stop working.

25. The remote control of claim 22, wherein updating the touch display devices on the remote control to display the key information of the corresponding mode according to the operation mode of the controlled device comprises:
when the operating mode of the controlled device is a text input mode, updating the touch display devices on the remote control to display input method key information in accordance with the text input mode according to the text input mode.

26. The remote control of claim 25, wherein updating the touch display devices on the remote control to display the input method key information in accordance with the text input mode according to the text input mode comprises:
detecting whether the controlled device is set with a customized input method;
when no customized input method is set, based on a preset default input method, filtering out target keys needed by the remote control according to the default input method;
updating initial display information on the touch display devices on the target keys required by the default input method to key information required for the default input method;
when a customized input method has been set, based on the customized input method, filtering out target keys needed by the remote control according to the customized input method;
updating initial display information on the touch display devices on the target keys required by the customized input method to key information required for the customized input method.

27. The remote control of claim 22, wherein when the key update information is not received, obtaining the operating mode of the controlled device corresponding to the remote control comprises:
detecting whether a mode switch key on the remote control is clicked when the key update information is not received;
when the mode switch key on the remote control is clicked, obtaining the operation mode of the controlled device corresponding to the remote control.

28. The remote control of claim 19, wherein the detection of whether the key update information is received comprises:
detecting whether key update information sent by a controlled device of the remote control is received, the key update information sent by the controlled device being information obtained from a cloud of the remote control.
